(19) United States
(12) Patent Application Publication
(10) Pub. No.: US 2026/0112196 A1
(43) Pub. Date: Apr. 23, 2026

(54) METHOD AND DEVICE FOR DETERMINING THE NUMBER OF PARTIAL PALM PRINTS TO BE ACQUIRED IN ORDER TO RECONSTRUCT THE ENTIRETY OF A PALM PRINT, AND CORRESPONDING ACQUISITION METHOD AND SYSTEM

(71) Applicant: IDEMIA PUBLIC SECURITY FRANCE, Courbevoie (FR)

(72) Inventors: Olivier TOURET, Courbevoie (FR); Laurent KAZDAGHLI, Courbevoie (FR)

(73) Assignee: IDEMIA PUBLIC SECURITY FRANCE, Courbevoie (FR)

(21) Appl. No.: 19/363,965

(22) Filed: Oct. 21, 2025

(30) Foreign Application Priority Data
Oct. 21, 2024 (FR) FR2411448

(51) Int. Cl. G06V 40/12

(52) U.S. Cl. CPC G06V 40/1371; G06V 40/1376

(57) ABSTRACT

A method for determining a number of partial palm-print images to be acquired using a papillary print acquisition device, the papillary print acquisition device being equipped with an acquisition area, a size of the acquisition area being smaller than an area of a palm representative of a population of individuals.

### FIELD OF THE INVENTION

The invention relates to the field of biometric imaging, and in particular to palm-print imaging.

### PRIOR ART

It is common to acquire dactylograms, generally better known by the general term “papillary prints”, which encompasses “fingerprints” and “palm prints”. Fingerprints are patterns formed by the traces left by the dermatoglyphics of the fingers, and palm prints are patterns formed by the traces left by the dermatoglyphics of the palms of the hands. The dermatoglyphics are the superficial furrows formed on the palms, the soles and the tip of the fingers by the dermal ridges and arranged in lines or whorls. They are unique to each individual. The patterns that they form constitute a biometric “identity card” by virtue of which an individual is able to be identified. It is common practice to take fingerprints in various administrative procedures conducted by state institutions and in operations carried out by law-enforcement agencies in relation to a suspect or to a defendant in the context of an infraction, of an offence, of a crime, or of a criminal investigation.

It is known to acquire a complete palm print using devices equipped with an acquisition area allowing an entire palm of an individual to be acquired in a single acquisition, regardless of the size of the palm. However, such a device is bulky and not very transportable. In practice, especially in the context of field activities, a smaller mobile device is preferable because it is more ergonomic. One example of a common mobile device is a device with an acquisition area

the dimensions of which conform to the “FAP 60”standard (76 mm×81 mm).

However, the average width of a palm of a male individual is 89 mm. Therefore, such a device does not allow the palm print of the entirety of the palm of the vast majority of individuals to be acquired in a single acquisition.

One solution is to acquire partial palm prints and then reconstruct the entirety of the palm using image processing.

EP 4 273 815 A1 describes a method for reconstructing a palm from images such as these of partial palm prints having overlapping areas.

Nevertheless, the completeness and accuracy of such a reconstruction mainly rely on the coverage of the palm that the partial print images are liable to allow during their assembly. However, it is common for the number of partial fingerprint images to be insufficient and/or for these images not to cover all the relevant areas of the palm. Faced with this problem, a human

operator acquiring partial palm prints of an individual using a small acquisition device, with a view to reconstructing the entirety of a palm print, tends to multiply, often unnecessarily, the number of acquisitions, even though this does not guarantee that the whole of the palm will actually be covered. The result is a waste of time and a lack of operational efficiency.

### SUMMARY OF THE INVENTION

The invention makes it possible to improve reconstruction of whole palm prints from partial palm prints by determining a number of partial palm prints to be acquired to cover the entirety of the palm of a hand. In certain embodiments, the invention also allows the risk of operator error to be decreased by means of partial print acquisition sequence, in which each acquisition corresponds to one particular position of a palm of an individual with respect to the acquisition area of the acquisition device.

According to a first aspect of the invention, a method for determining the number of partial palm-print images to be acquired using a papillary print acquisition device is provided, said papillary print acquisition device being equipped with an acquisition area the size of which

is smaller than the area of a palm representative of a population of individuals, the method comprising the following steps implemented by a computer:
a)obtaining an image of a papillary print of an individual acquired using said acquisition device;
b) measuring, using the papillary print image, at least one geometric dimension of the papillary print;
c) estimating at least one geometric dimension of the palm of the individual from at least one geometric dimension of the papillary print, for example using one or more interpolation functions that are preferably calculated on statistics of various measurements of a plurality of individuals;
d) determining, from the at least one estimated geometric dimension of the palm of the individual, a number N of acquisitions of images I₁, . . . I_{N} of the palm of the individual required to cover the entire area of the palm, each acquisition corresponding to one position P₁, . . . P_{N} of the palm of the individual on the acquisition area of the acquisition device.

The invention is advantageously supplemented by the following features, which may be implemented singly or in any technically possible combination thereof:
In step a), the papillary print image comprises at least one fingerprint of the individual, and in step c) a first geometric dimension of the palm of the individual is the width of the palm, said width of the palm being estimated using a first interpolation function based on the measured geometric dimension of the papillary print, and a second geometric dimension of the palm of the individual is the length of the palm, said length of the palm being estimated using a second interpolation function based on the measured geometric dimension of the papillary
   print.
The first interpolation function is a function for interpolating the width of palms of a plurality of individuals based on at least one geometric dimension of their fingerprints and the second interpolation function is a function for interpolating the length of palms of a plurality of individuals based on one length of their palm.
In step b), the at least one measured geometric dimension of the fingerprint is selected from the width, length or area of the fingerprint or a combination thereof.
In step a), the papillary print image comprises the interdigital part of the palm of the individual, in step b) the width of the interdigital part is measured, and in step c) the width and length of the palm are estimated using a first interpolation function for interpolating palm width
   and a second interpolation function for interpolating palm length based on the measured width of the interdigital part, respectively.
In step b), at least one distance between two papillary ridges is measured in the papillary print image taken in step a); and in step c), the width and length of the palm are estimated using a first function for interpolating a width and a second function for interpolating
   a length of the palm depending on the distance measured between two papillary ridges, respectively.
Step d) comprises the following sub-steps:
comparing the estimated geometric dimension of the palm with the geometric dimensions of the acquisition area of the acquisition device;
determining a position P₁, . . . P_{N} for each acquisition of an image I₁, . . . I_{N} of the palm of the individual on the acquisition area of the acquisition device from the result of the comparison.
If the estimated width and estimated length are less than the geometrical dimensions of the acquisition area of the acquisition device then the number N of acquisitions of images is
   a single image I1 associated with a position P1 centered on the acquisition area of the acquisition device.
If either the estimated length or estimated width of the palm is greater than the geometrical dimensions of the acquisition area of the acquisition device, then:
   a) when it is a question of length, the number N of acquisitions of images is at least two images I1, I2 associated with a first position P1 corresponding to an upper part of the palm, and preferably at least to the upper half of the palm, and with a second position P2
   corresponding to a lower part of the palm, and preferably at least to the lower half of the palm, respectively; or
b) when it is a question of width, the number N of acquisitions of images is at least two images I1, I2 associated with a first position P1 corresponding to the right half of the palm, and
   with a second position P2 corresponding to the left half of the palm, respectively.
If the estimated width and estimated length are greater than the geometrical dimensions of the acquisition area of the acquisition device, then the number N of acquisitions of images is at least four images I1, I2, I3, I4, associated with a first position P1 corresponding to the upper half of the palm, with a second position P2 corresponding to the lower half of the
   palm, with a third position P3 corresponding to the right half of the palm, and with a fourth position P4 corresponding to the left half of the palm, respectively.

According to a second aspect, the invention provides a method for obtaining an image of a print, comprising the following steps:
e) acquisition, using a papillary print acquisition device equipped with an acquisition area the size of which is smaller than the area of a palm representative of a population of individuals, of a number N of acquisitions of images I₁, . . . I_{N} of the palm of the individual required to cover the entirety of the area of the palm, each acquisition corresponding to one position P₁, . . . P_{N} of the palm of the individual on the acquisition area of the acquisition device, said number being obtained by means of a method according to the first aspect of the
   invention;
f) verification that the acquired images cover the entirety of the palm of the individual;
g) acquisition of at least one corrective image in a given position if the acquired images do not cover the entirety of the palm;
h) reconstruction of the entirety of the palm from the images acquired in step e) and possibly in step g).

The invention according to the second aspect is advantageously supplemented by the following features, which may be implemented singly or in any technically possible combination thereof:
The verification comprises the following steps: reconstructing the palm from the acquired images; calculating the width and/or length of the reconstructed palm; comparing the calculated width and/or calculated length with a reference value.
In step e), the acquired images comprise at least one palm edge, the verification comprising the following steps: detecting palm edges in the acquired images; verifying the presence of all the palm edges, at least one corrective image being acquired if a palm edge is
   missing.
The method according to the second aspect further comprises the following steps:
   calculating width and/or length from the palm edges; comparing the calculated width and/or calculated length with a reference value, at least one corrective image being acquired depending on the result of the comparison.

According to a third aspect, the invention provides a papillary print acquisition device comprising a sensor, the sensor comprising an acquisition area smaller than the entirety of the area of the palm for the whole of a population of individuals, the device comprising a computer configured to implement a method according to the second aspect of the invention.

### DESCRIPTION OF THE FIGURES

FIG. 1 is a schematic representation of one example of a mobile print acquisition device.

FIG. 2 illustrates prints classified into 11 classes C1-C11 in a known manner.

FIG. 3 illustrates steps of a method for determining an image of a palm print according

to one embodiment of the invention.

FIG. 4 illustrates steps of a method for determining a number of images to be acquired according to one embodiment of the invention.

FIG. 5 illustrates a position of the hand for acquisition of a print in a first embodiment of the invention.

FIG. 6 illustrates a position of the hand for acquisition of a print in a second embodiment of the invention.

FIG. 7 illustrates a position of the hand for acquisition of a print in a first embodiment of the invention.

FIG. 8 illustrates the correlation between the width, in pixels, of a print of a finger of an individual's hand and the width, in pixels, of the palm of the hand of the individual.

FIG. 9, FIG. 10, FIG. 11, and FIG. 12 illustrate various hand positions for various acquisitions of images of the palm of the hand.

In all of the figures, elements that are similar have been designated by identical references.

### DETAILED DESCRIPTION OF THE INVENTION

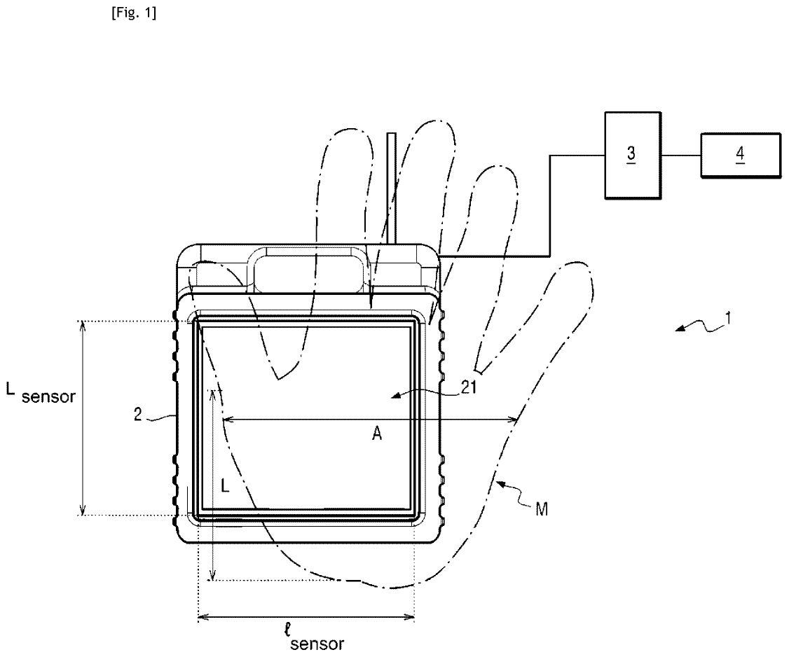

FIG. 1 shows a contact mobile device 1 for acquiring papillary prints comprising a sensor 2, a computer 3 configured to implement steps which will be described below and a memory 4 for storing print images and code instructions for implementing various steps (see below). The computer 3 and the memory 4 are for example integrated into a PC, a tablet or a smartphone or another type of system provided with a user interface. The computer 3 may be independent of the sensor 2 or indeed be integrated directly into the latter.

The sensor 2 is of small size, which guarantees the mobility of the device. It conforms to the FAP 60 standard, and has an acquisition area 21 that is 3×3.2 inches, i.e. 76×81 mm, in size.

The acquisition area 21 of the sensor is generally rectangular. An operator prompts an individual to place their hand M in a determined position. One or more fingers, the hand or part of the hand may be proffered depending on the type of fingerprint or palm print that needs to be acquired.

The finger and palm prints may be classified into multiple membership classes, each of the classes corresponding to a specific anatomical region of the palmar face of the hand to which they correspond. A “palmar face” of a hand is understood to mean the face of the hand containing the palm of the hand, in contrast to the dorsal face. The palmar face comprises the palm and all of the fingers, in other words the thumb, the index finger, the middle finger, the ring finger, the auricular finger, the thenar eminence, the hollow of the palm and the hypothenar eminence. The palm of a hand is the part of the palmar face between the wrist and the base

of the fingers. These definitions correspond to those commonly accepted in anatomy.

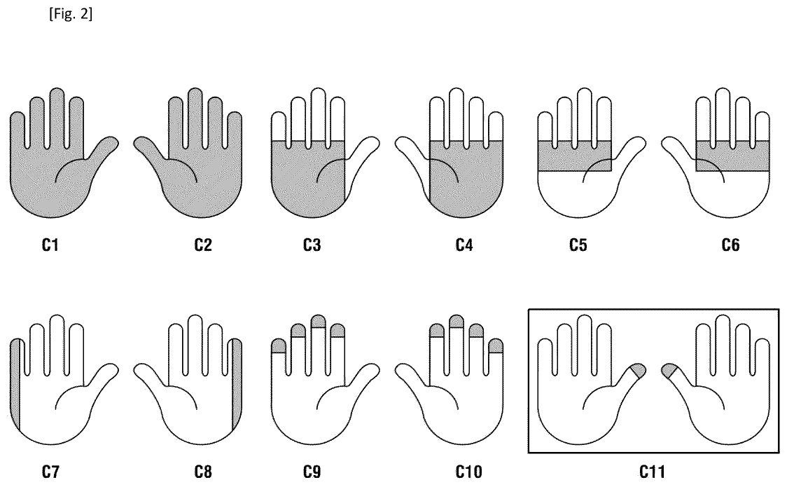

In practice, with reference to FIG. 2, it is possible to distinguish, among the various types of dactylograms, 11 membership classes C1-C11 corresponding to different anatomical regions of the palmar face of the hand and adapted to a very large number of requirements and use cases: the complete right hand (C1); the complete left hand (C2); the palm of the right

hand (C3); the palm of the left hand (C4); the interdigital area of the right hand (C5); the interdigital area of the left hand (C6); the right writer's palm (C7), the left writer's palm (C8); at least two, preferably three, and preferably four fingers of the right hand (C9); at least two, preferably three, and preferably four fingers of the left hand (C10); and the thumbs of the right and left hands (C11).

The sensor 2, the dimensions of the acquisition area of which comply with the FAP 60 standard (76 mm×81 mm), does not allow a complete palm print to be acquired in a single acquisition for most individuals. The average width of the palm of the hand of a male individual is 89 mm. In particular, the dactylograms of classes C3 and C4 shown in FIG. 2 cannot be acquired in a single acquisition for most individuals.

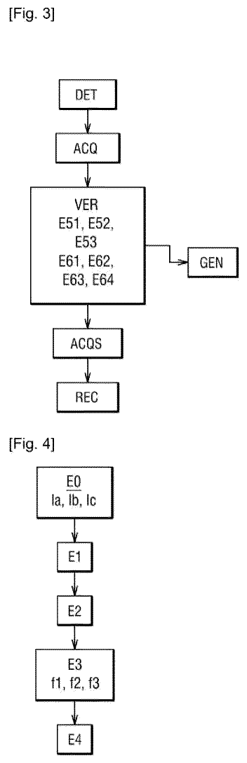

As illustrated in FIG. 3, using the acquisition device, a number of partial palm-print images to be acquired in order to allow a complete acquisition of the palm of the hand of the individual is determined (step DET), each image corresponding to one position of the palm of the individual on the acquisition area 21 of the sensor.

Complementarily, a step of acquisition (step ACQ) of each image is implemented.

Complementarily, a step of verification (step VER) that the one or more acquired images indeed allow the entire palm to be covered is implemented and if the verification is inconclusive then corrective acquisitions may be required and performed (step DETS) or an alert invalidating the acquisitions may be generated (step GEN).

FIG. 4 illustrates all the sub-steps of the step of determination (see step DET mentioned in FIG. 3) of a number N of acquisitions of images of the palm of the individual required to cover the entirety of the area of the palm, each acquisition corresponding to one position P1, . . . PN of the palm of the individual on the acquisition area 21 of the device 1 for acquiring papillary prints.

Complementarily, it is also a question of obtaining one or more instructions regarding where the hand of the individual should be positioned on the acquisition area 21, which instructions may be visual or audible as presented above.

Thus, the step of determination (step DET) of the number N of acquisitions of images of the palm of the individual required to cover the entirety of the surface of the palm comprises a prior step of acquisition (step E0) of an initial image (see images Ia, Ib, Ic in FIGS. 5, 6 and

7 respectively) of a papillary print of the individual. To this end, an individual is prompted to position their hand M by an operator on the acquisition area 21 of the sensor 2. This initial image (Ia, Ib, Ic) is received (step E1) by the computer with a view to being processed. When a given acquisition of an image is mentioned, what is meant is that each image is associated with one particular position of the hand of the individual on the acquisition area 21 of the sensor
2.

Using the initial image Ia, Ib, Ic, a geometric dimension of the papillary print of the individual is measured (step E2).

Next, based on the measured geometric dimension, at least one geometric dimension of the palm of the individual is estimated (step E3) using one or more interpolation functions. The geometric dimension of the palm of the individual may be selected from length, width and/or area. For reasons of simplification, the palm is generally assumed to be rectangular in shape.

Depending on the geometric dimension of the palm of the individual thus estimated, the number N of acquisitions, and the positions of the hand corresponding to these N acquisitions,

that will allow the entirety of the palm of the individual to be covered, are determined (step E4).

Each position is stored in the memory 4 of a data-processing device in the form of visual and/or audible instructions with a view to subsequent acquisition of each image (step ACQ).

### First Embodiment

In a first embodiment, with reference to FIG. 5, the initial image Ia comprises at least one fingerprint of the individual, for example the fingerprints of the four fingers of the left hand or of the right hand. In the example illustrated in FIG. 5, the individual positions their fingers on the acquisition area 21 of the sensor 2 so that the ends of the four fingers (shown blackened) are positioned on the sensor, and the initial image is then acquired (step E0a).

In this initial image, at least one geometric dimension of one or more fingerprints is measured (step E2). Such a measurement is made in pixels or in dimensional units, these two

quantities generally being proportional. One geometric dimension of the fingerprint is the width, length or area of the fingerprint.

Next, an estimate of the width of the palm is made (step E3) based on the geometrical dimension of the previously measured prints.

Such an estimate of width is, for example, made based on reference measurements giving a geometric dimension of the fingerprints for a palm width of reference individuals, these reference measurements being stored in a memory 4.

Thus, for a measured geometric print dimension, it is a question of determining the closest geometric reference-print dimension to deduce therefrom the width of the palm of the hand of the individual.

To do this, a first interpolation function f1 is obtained from a set of measurements of the palm widths of a plurality of individuals as a function of at least one geometric dimension of their fingerprints.

The first interpolation function f1 is, for example, obtained from an analysis of the correlation between a geometric dimension of fingerprints and the width of palms of a statistical

population of reference individuals. The geometric dimension of the fingerprints may be a dimension of one finger in particular, or of a combination of all or some of the fingers, with averaging, weighting or not.

Preferably, a first interpolation function f1 for interpolating the width A of the palm from the width of a fingerprint of a finger is used to obtain the width of the palm. Thus, based on the

measurement of a width of the fingerprint of a finger of the individual, an estimate of the width of their palm is obtained (step E3).

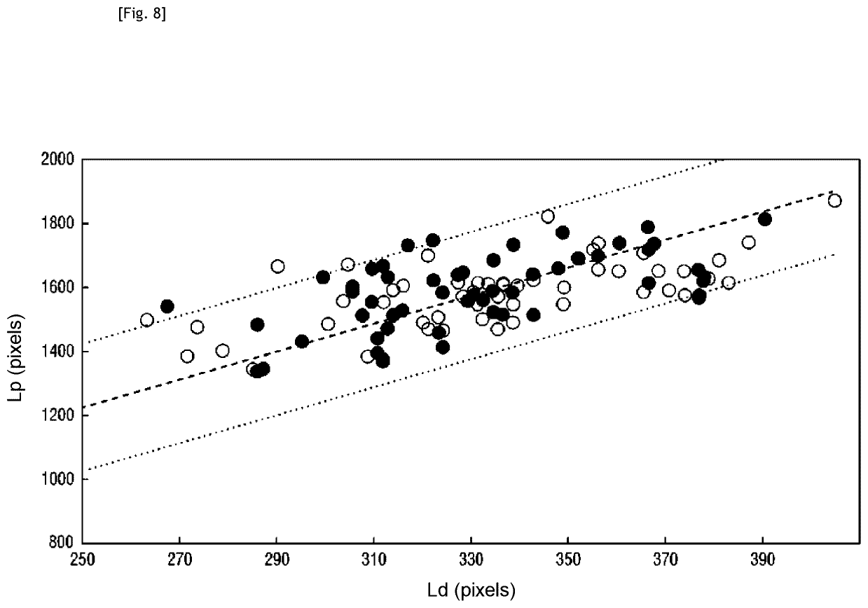

One example of correlation between the width of the fingerprints of various fingers and the width of the palm is illustrated in FIG. 8. In this figure, the dimensions are expressed in pixels. The x-axis represents the width of the middle finger and the y-axis represents the width

of the palm for each hand of a plurality of individuals. The center line represents the linear relationship between the width of the palm and the width of a fingerprint of a finger (constant finger/palm ratio). The upper and lower lines represent the upper and lower limits of a 95% confidence interval centered on the center line. Almost all the measurement points lie between the upper and lower lines.

Complementarily, any geometric parameter obtained with a first interpolation function f1 will be accompanied by a confidence interval.

Based on the width A of the palm, the length L of the palm is determined using a second interpolation function f2 (step E3).

The second interpolation function f2 is, for example, the result of anthropometric studies especially indicating the 5^{th} and 95^{th} percentiles of measurements of palms widths and lengths.

One example of a study is described in NASA MAN-SYSTEMS STANDARDS—3 ANTHROPOMETRY AND BIOMECHANICS, Revision B, July 1995, Volume 1, Section 3.

In this example, the second interpolation function f2 makes it possible to establish a correspondence between the width and the length of the palm of the individual, for example via a linear relationship between palm width and length based on the 5^{th} and 95^{th} percentiles of these lengths and widths.

### Second Embodiment

In a second embodiment, with reference to FIG. 6, the initial image Ib of the papillary print comprises the interdigital part of the palm of the individual. This image may be acquired (step E0b) by positioning the interdigital part of the hand M of the individual along the diagonal of the acquisition area 21 of the sensor 2 as illustrated in FIG. 6. The interdigital part corresponds to the top of the palm at the base of the fingers.

By way of example, with a sensor 2 with a diagonal of 111 mm, it is possible to acquire the width of the palm (measured in the interdigital part) for almost all individuals.

Specifically, according to certain anthropometric studies, and especially to the study mentioned above, 95% of male individuals have a palm width of less than 96 mm and 50% of male individuals have a palm width of less than 89 mm (7 mm difference). A diagonal of 111 mm (therefore 15 mm more than 96 mm) is sufficient for the vast majority of individuals.

Using the initial image Ib, the width of the interdigital part is measured (step E2), image processing for example being used to measure the edge-to-edge distance of the palm. The width of the interdigital part corresponds approximately to the width of the palm.

In a similar manner to the first embodiment, the length L of the palm of the individual is estimated using a function f3 for interpolating a palm length depending on a width of the interdigital part.

### Third Embodiment

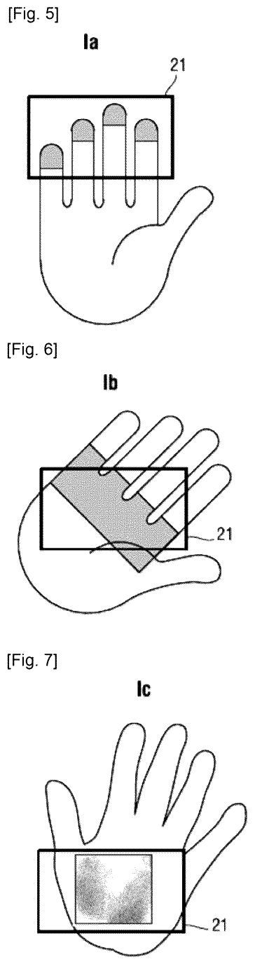

In a third embodiment, the initial papillary print image comprises papillary ridges. The initial image may be an image of part of the palm and/or some of the fingers, as illustrated in the example of FIG. 7. In this example, the initial image may be acquired (step E0) with the hand of the individual positioned so that the central part of the palm makes good contact with the acquisition area 21 of the sensor 2. By way of example, FIG. 7 shows the position in which

the hand of the individual must be to acquire (step E0) an initial image Ic featuring the central part of the palm (in grayscale).

Based on the initial image Ic, at least one distance between two papillary ridges is measured. Alternatively, an average of widths between papillary ridges may be used to achieve a better representative of the statistic.

Next, based on the measured distance between two papillary ridges, it is possible to deduce the length and width of the palm of the individual using a function interpolating a width and a length of the palm as a function of the measured distance between two papillary ridges. One example of such a function is described in the article Sharma et al. (2022). Is fingerprint

ridge density influenced by hand dimensions? Acta Biomed. This function may advantageously be refined using a campaign of measurements on a representative population of individuals.

### Determining the Number of Acquisitions N (Step E4)

Once the width and length of the palm have been obtained, it is a question of determining the number N of acquisitions required to cover the entirety of its area, and optionally of generating instructions to guide the operator and the individual whose fingerprints are being acquired (step E4). Different cases may be distinguished between.

Case 1)—if the estimated length L and width A of the palm are less than the geometrical dimensions of the acquisition area 21 of the sensor 2 (length of the acquisition area Lₛₑₙₛₒᵣ and

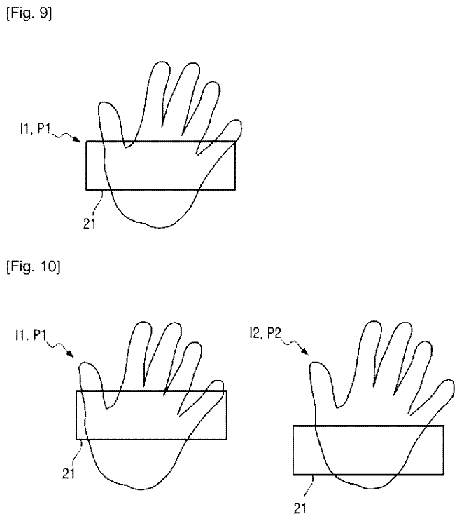

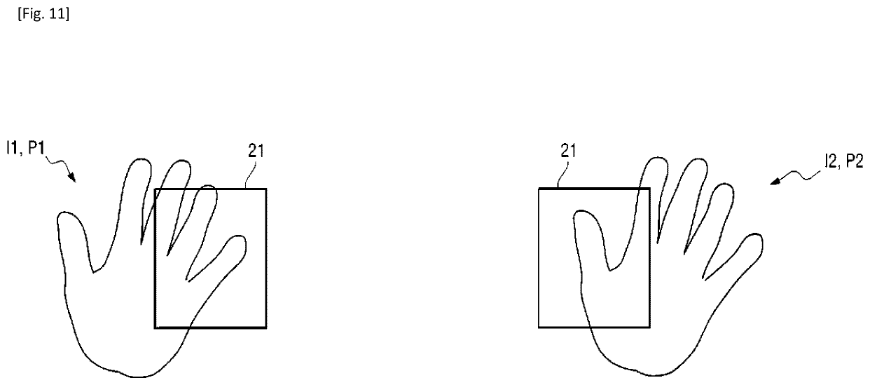

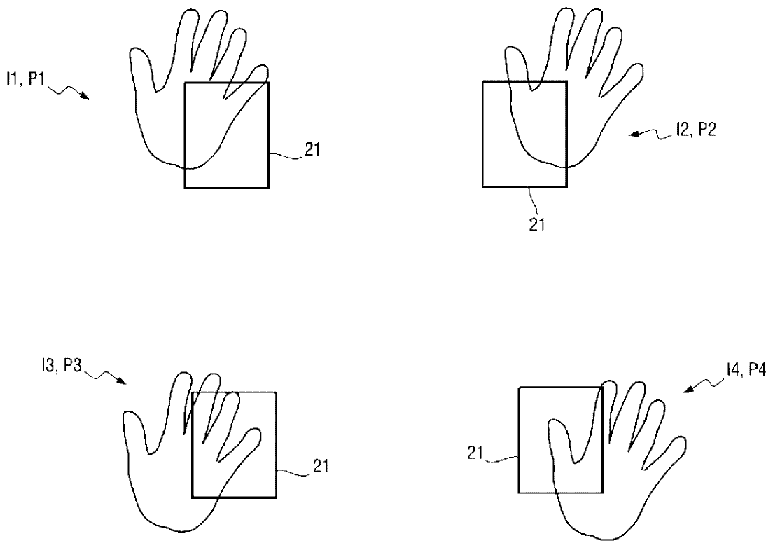

width of the acquisition area Iₛₑₙₛₒᵣ) (for example 8.1 cm in length and 7.6 cm in width) then the number N of acquisitions is a single image I1 associated with a position P1 of the hand centered on the acquisition area (see FIG. 9).

Case 2)—if the estimated length L of the palm is greater than the length Lₛₑₙₛₒᵣ of the acquisition area 21 of the sensor 2 and if the estimated width A of the palm is less than the width of the sensor Iₛₑₙₛₒᵣ, then the number N of acquisitions of images is two images I1, I2 associated with a first position P1 corresponding to an upper part of the palm, and preferably at least to the upper half of the palm, and with a second position P2 corresponding to a lower part of the palm, and preferably at least to the lower half of the palm (see FIG. 10), respectively.

Case 3)—if the estimated length L is less than the length Lₛₑₙₛₒᵣ of the acquisition area 21 of the sensor 2 and if the estimated width A of the palm is greater than the width Iₛₑₙₛₒᵣ of the acquisition area 21 then the number N of acquisitions is two images I1, I2 (see FIG. 11) associated with a first position P1 corresponding to the left half of the palm, and with a second position P2 corresponding to the right half of the palm, respectively.

Case 4)—if the estimated length L of the palm is greater than the length Lₛₑₙₛₒᵣ of the acquisition area 21 of the sensor 2 and if the estimated width A of the palm is greater than the width of the sensor Iₛₑₙₛₒᵣ, then the number N of acquisitions of images is four images I1, I2, I3,

I4 associated with a first position P1 corresponding to the upper half of the palm, with a second position P2 corresponding to the lower half of the palm, with a third position P3 corresponding to the right half of the palm, and with a fourth position P4 corresponding to the left half of the palm, respectively. N=4 acquisitions I1, I2, I3, I4 in total are therefore required, one for each
of the following palm sectors (see FIG. 12): top-left, top-right, bottom-left and bottom-right. It will be noted that various orders of acquisition are possible but it is in practice preferable not to start with two sectors located diagonally to each other because the overlap of the images is less in this case (specifically, the overlap allows the palm to be reconstructed from the various acquisitions).

In cases 1, 2 and 4, partial images in various positions are required based on the estimates of the geometric dimensions of the palm. Depending on the case, only a small number of images is required compared to a process in which a much higher number is required to be sure to cover all the palm.

### Obtaining a Print Image

After having determined the number of acquisitions required to completely cover a palm of an individual, acquisition (step ACQ) on the acquisition area 21 of the sensor 2 of each image I₁, . . . I_{N} is carried out in the position P₁, . . . P_{N} that is associated therewith.

In certain embodiments, the method further comprises a verification (VER) that the acquired images cover the entirety of the palm and an acquisition (ACQS) of at least one corrective image in a given position if the acquired images do not cover the entirety of the palm. Lastly, a reconstruction (step REC) of the entirety of the palm from the acquired images possibly supplemented by at least one corrective image is performed.

The verification step may be implemented in a number of ways.

In a first way, the palm is first reconstructed (step E51) from the acquired images and then the width and/or length of the reconstructed palm are/is calculated (step E52). Next, the calculated width and/or the calculated length are/is compared with one or more reference values (step E53). Next, at least one corrective image is acquired (step ACQS) in a given position depending on the result of the comparison.

The entirety of the palm may be reconstructed from the acquired images using various methods, especially the method described in the document EP 4 273 815 A1. Such a reconstruction (step E51) comprises steps of registration and of fusion of the various images (in the case where at least two images in two different positions are required).

If the width and/or length of the reconstructed palm are/is less than a reference value (a threshold or an interval of values), it is likely that the acquired images are of insufficient quality—in particular, the hand might not have been correctly positioned to cover the entire area of the palm (the same reasoning may apply to the length of the hand). A number of corrective acquisitions (step ACQS) are then acquired to acquire one or two additional acquisitions to cover the entire width and/or one or two additional acquisitions to satisfactorily cover the entire length of the palm. The acquisition device may be configured to alert the operator using an audible or visual signal.

In a second way, if the acquired images contain at least one palm edge then the palm edge is detected (step E61) in the acquired images, in order to detect all the boundaries of the palm (step E62). If a palm edge is missing, then at least one corrective image is acquired (step

### ACQS).

If these borders are detected, if the width and length (and therefore the area) detected are greater than a reference value, and if the detected shape is consistent with that of a palm, it may be deduced therefrom that the whole palm has indeed been detected. In contrast, if one or more borders are missing, and/or if the detected length or width is less than the lower limit

of the confidence interval, then at least one corrective image is acquired with a view to detecting the corresponding borders.

In particular, the corrective acquisitions consist in positioning the part of the palm corresponding to the missing edge toward the center of the acquisition area 21. For example, if the left edge of the palm is missing, it means that the left part of the palm has been placed off to the left of the left part of the sensor, and therefore the individual is prompted to position the left part of their palm toward the center of the sensor 2, or advantageously between the center and the left of the sensor such that the left edge is in the acquisition area 21. If the left edge and top edge are missing, then the individual is prompted to position the top-left part of their palm toward the center or at least (and advantageously) between the center and the top-left

quadrant.

In a third way that is complementary to the second way, the width and/or length are calculated (step E63) from the palm edges and the calculated width and/or the calculated length are compared with reference values (step E64). Such reference values are, for example,

the lower and upper limits of a confidence interval associated with the interpolation functions (see above).

If a calculated width or length is greater than the reference values, it is likely that the hand has been angularly positioned on the sensor incorrectly (“skewed”), the measurement of the diagonal having been mistakenly considered for a measurement of the width or length of

the palm. In order to limit the risk of error during the reconstruction of the complete palm print, it is advantageous to generate (step GEN) an alert message intended for the operator, telling them to check the position of the hand and restart the acquisition.

1. A method for determining a number of partial palm-print images to be acquired using a papillary print acquisition device, said papillary print acquisition device being equipped with an acquisition area a size of which is smaller than the area of a palm representative of a population of individuals, the method comprising the following steps implemented by a computer:
a) obtaining an image of a papillary print of an individual acquired using said acquisition device;
b) measuring, using the papillary print image, at least one geometric dimension of the papillary print;
c) estimating at least one geometric dimension of the palm of the individual based on at least one geometric dimension of the papillary print; and
d) determining, from the at least one estimated geometric dimension of the palm of the individual, a number N of acquisitions of images I₁, . . . I_{N} of the palm of the individual required to cover an entire area of the palm, each acquisition corresponding to one position P₁, . . . P_{N} of the palm of the individual on the acquisition area of the acquisition device.

2. The method as claimed in claim 1, wherein the papillary print image comprises at least one fingerprint of the individual, and in step c) a first geometric dimension of the palm of the individual is a width of the palm, said width of the palm being estimated using a first interpolation function based on the measured geometric dimension of the papillary print, and a second geometric dimension of the palm of the individual is a length of the palm, said length of the palm being estimated using a second interpolation function based on the measured geometric dimension of the papillary print.

3. The method as claimed in claim 2, wherein the first interpolation function is a function for interpolating the width of palms of a plurality of individuals based on at least one geometric dimension of their fingerprints and the second interpolation function is a function for interpolating the length of palms of a plurality of individuals based on one length of their palm.

4. The method as claimed in claim 2, wherein the at least one geometric dimension of the fingerprint is selected from a width, length or area of the fingerprint or a combination thereof.

5. The method as claimed in claim 1, wherein the papillary print image comprises the interdigital part of the palm of the individual, and in step b) a width of the interdigital part is measured, and in step c) a width and length of the palm are estimated using a first interpolation function for interpolating palm width and a second interpolation function for interpolating palm length based on the measured width of the interdigital part, respectively.

6. The method as claimed in claim 1, wherein, in step b), at least one distance between two papillary ridges is measured in the papillary print image taken in step a); and in step c), a width and length of the palm are estimated using a first function for interpolating a width and a second function for interpolating a length of the palm depending on the distance measured between two papillary ridges, respectively.

7. The method as claimed in claim 1, wherein step d) comprises the following substeps:
comparing the at least one estimated geometric dimension of the palm with the geometric dimensions of the acquisition area of the acquisition device; and
determining a position P₁, . . . P_{N} for each acquisition of an image I₁, . . . I_{N} of the palm of the individual on the acquisition area of the acquisition device from the result of the comparison.

8. The method as claimed in claim 7, wherein if the estimated width and estimated length are less than the geometrical dimensions of the acquisition area of the acquisition device then the number N of acquisitions of images is a single image I1 associated with a position P1 centered on the acquisition area of the acquisition device.

9. The method as claimed in claim 7, wherein if either the estimated length or estimated width of the palm is greater than the geometrical dimensions of the acquisition area of the acquisition device, then
when it is a question of length, the number N of acquisitions of images is at least two images I1, I2 associated with a first position P1 corresponding to an upper part of the palm, and preferably at least to the upper half of the palm, and with a second position P2 corresponding to a lower part of the palm, and preferably at least to the lower half of the palm, respectively; or
when it is a question of width, the number N of acquisitions of images is at least two images I1, I2 associated with a first position P1 corresponding to the right half of the palm, and with a second position P2 corresponding to the left half of the palm, respectively.

10. The method as claimed in claim 7, wherein if the estimated width and estimated length are greater than the geometrical dimensions of the acquisition area of the acquisition device, then the number N of acquisitions of images is at least four images I1, I2, I3, I4, associated with a first position P1 corresponding to the upper half of the palm, with a second position P2 corresponding to the lower half of the palm, with a third position P3 corresponding to the right half of the palm, and with a fourth position P4 corresponding to the left half of the palm, respectively.

11. A method for obtaining an image of a papillary print of an entire palm, comprising the following steps:
e) acquisition using a papillary print acquisition device equipped with an acquisition area the size of which is smaller than the area of a palm representative of a population of individuals, of a number N of acquisitions of images I₁, . . . I_{N} of the palm of the individual required to cover the entirety of the area of the palm, each acquisition corresponding to one position P₁, . . . P_{N} of the palm of the individual on the acquisition area of the acquisition device, said number being obtained by means of a method according to claim 1;
f) verification that the acquired images cover the entirety of the palm of the individual;
g) acquisition of at least one corrective image in a given position if the acquired images do not cover the entirety of the palm; and
h) reconstruction of the entirety of the palm from the images acquired in step e) and possibly in step g).

12. The method as claimed in claim 11, wherein the verification comprises the following steps:
reconstructing the palm from the acquired images;
calculating the width and/or length of the reconstructed palm; and
comparing the calculated width and/or calculated length with a reference value.

13. The method as claimed in claim 11, wherein, in step e), the acquired images comprise at least one palm edge, the verification comprising the following steps:
detecting palm edges in the acquired images; and
verifying the presence of all the palm edges, at least one corrective image being acquired if a palm edge is missing.

14. The method as claimed in claim 13, further comprising the following steps:
calculating width and/or length from the palm edges; and
comparing the calculated width and/or calculated length with at least one reference value, at least one corrective image being acquired depending on the result of the comparison.

15. A papillary print acquisition device comprising a sensor, the sensor comprising an acquisition area smaller than the entirety of the area of the palm for the whole of a population of individuals, the device comprising a computer configured to implement a method as claimed in claim 1.

16. The method as claimed in claim 3, wherein the at least one geometric dimension of the fingerprint is selected from a width, length or area of the fingerprint or a combination thereof.

17. The method as claimed in claim 2, wherein step d) comprises the following substeps:
comparing the at least one estimated geometric dimension of the palm with the geometric dimensions of the acquisition area of the acquisition device; and
determining a position P₁, . . . P_{N} for each acquisition of an image I₁, . . . I_{N} of the palm of the individual on the acquisition area of the acquisition device from the result of the comparison.

18. The method as claimed in claim 3, wherein step d) comprises the following substeps:
comparing the at least one estimated geometric dimension of the palm with the geometric dimensions of the acquisition area of the acquisition device; and
determining a position P₁, . . . P_{N} for each acquisition of an image I₁, . . . I_{N} of the palm of the individual on the acquisition area of the acquisition device from the result of the comparison.

19. The method as claimed in claim 4, wherein step d) comprises the following substeps:
comparing the at least one estimated geometric dimension of the palm with the geometric dimensions of the acquisition area of the acquisition device; and
determining a position P₁, . . . P_{N} for each acquisition of an image I₁, . . . I_{N} of the palm of the individual on the acquisition area of the acquisition device from the result of the comparison.

20. The method as claimed in claim 4, wherein step d) comprises the following substeps:
comparing the at least one estimated geometric dimension of the palm with the geometric dimensions of the acquisition area of the acquisition device; and
determining a position P₁, . . . P_{N} for each acquisition of an image I₁, . . . I_{N} of the palm of the individual on the acquisition area of the acquisition device from the result of the comparison.
